(19) United States
(12) Patent Application Publication
(10) Pub. No.: US 2022/0076010 A1
(43) Pub. Date: Mar. 10, 2022

(54) METHOD OF GENERATING TEXT FEATURES FROM A DOCUMENT

(71) Applicant: KIRA INC., Toronto (CA)

(72) Inventors: Samuel Peter Thomas FLETCHER, Toronto (CA); Adam ROEGEIST, Toronto (CA); Alexander Karl HUDEK, Toronto (CA)

(21) Appl. No.: 17/016,211

(22) Filed: Sep. 9, 2020

(51) Int. Cl. G06K 9/00; G06F 40/166; G06F 7/32

(52) U.S. Cl. CPC G06K 9/00469; G06F 7/32; G06F 40/166; G06K 9/00463

(57) ABSTRACT

A method of generating text features from a document comprises one or more processors grouping text comprised in the document into multiple logical text blocks, wherein each of the logical text blocks comprises one or more tokens. One of the logical text blocks is selected for generating features. Thereafter, logical text blocks neighbouring the selected logical block are identified. Further, the processer qualifies one or more of the neighbouring logical text blocks for generating features. The processor generates features for one or more of the tokens in the selected logical block using the qualified logical text blocks.

### BACKGROUND

Unless otherwise indicated herein, the materials described in this section are not prior art to the claims in this application and are not admitted to being prior art by inclusion in this section.

### Field

The subject matter in general relates to generating text features. More particularly, but not exclusively, the subject matter relates to classifying text in a document by generating text features.

### Discussion of the Related Art

Millions of documents are produced every day that are reviewed, processed, stored, audited, and transformed into computer-readable data. Examples include educational forms, financial statements, government documents, human resource records, insurance claims, and legal paper, among many others. Documents typically comprise text segments, such as, headers, footers, heading, sub-headings and topics, among others. Such documents may be processed for identifying the text segments and classifying them.

Typically, each text segment may be encapsulated by a bounding block. Features may be generated, for use by classifiers, wherein features may be generated based on font, size, and context of tokens relative to other tokens within the segment.

Such conventional approach of feature generation has been observed to result in outcome, which may not be as desired in several scenarios.

In view of the forgoing discussion, there is a need for an improved technical solution for generating features from a document.

### SUMMARY

In an aspect, a method of generating text features from a document is provided. The method may be carried out by one or more processors. The method comprises grouping text in the document into multiple logical text blocks comprising one or more tokens. The processor may then select one of the logical text blocks for generating features and may further identify the logical text blocks neighbouring the selected logical block. The processor may qualify one or more of the neighbouring logical text blocks for generating features. Features are generated for the tokens in the selected logical block using the qualified logical text blocks.

### BRIEF DESCRIPTION OF DIAGRAMS

This disclosure is illustrated by way of example and not limitation in the accompanying figures. Elements illustrated in the figures are not necessarily drawn to scale, in which like references indicate similar elements and in which:

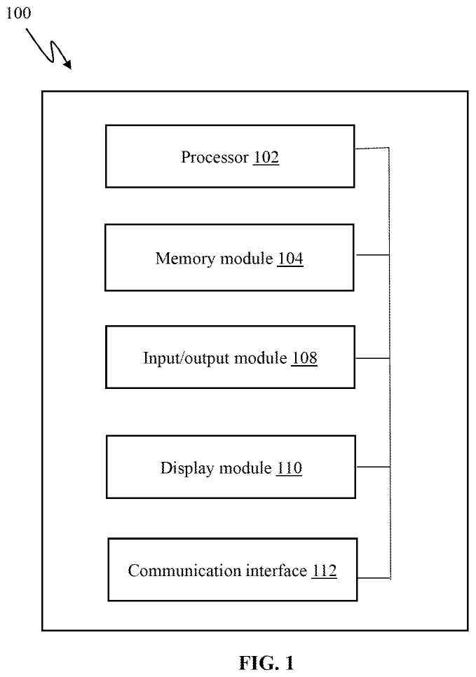

FIG. 1 illustrates a system 100 for generating text features from a document, in accordance with an embodiment;

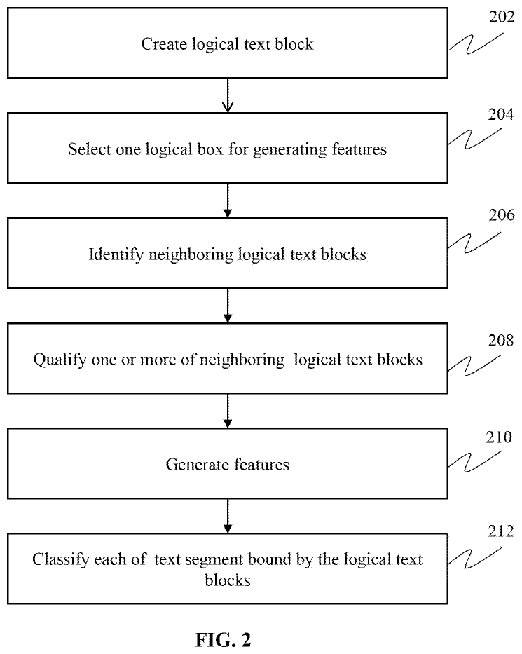

FIG. 2 is a flowchart illustrating the steps for generating text features from a document, in accordance with an embodiment;

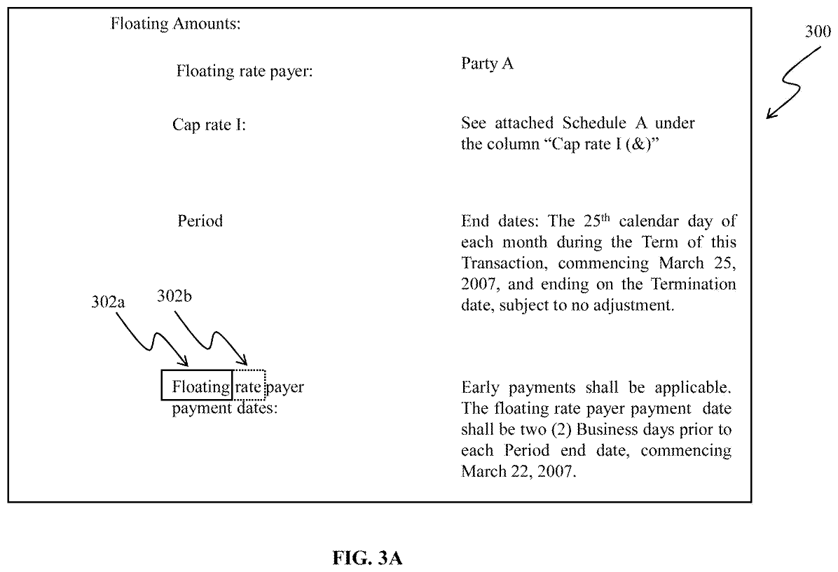

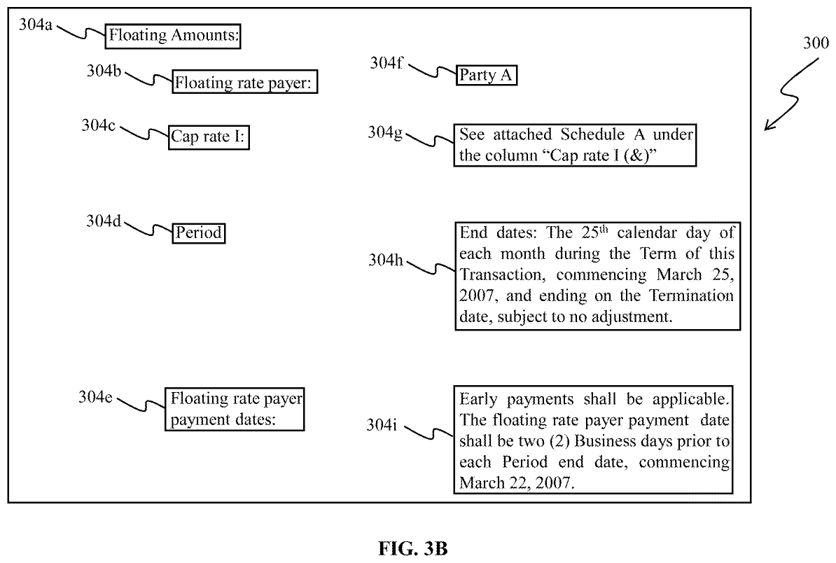

FIG. 3A illustrates a document 300, in accordance with an embodiment; and

FIG. 3B illustrates the document 300 having been processed to identify logical text blocks 304a-304i, in accordance with an embodiment

### DETAILED DESCRIPTION

The following detailed description includes references to the accompanying drawings, which form part of the detailed description. The drawings show illustrations in accordance with example embodiments. These example embodiments are described in enough detail to enable those skilled in the art to practice the present subject matter. However, it may be apparent to one with ordinary skill in the art that the present invention may be practised without these specific details. In other instances, well-known methods, procedures, and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken in a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

Referring to the figures, a system 100 for generating features from documents is provided. The steps of FIG. 2 for generating the features from documents may be executed by the system 100. As an example, a document 300 of FIGS. 3A and 3B may be processed by the system 100 for generating features. Document 300 may comprise several tokens. As an example, a token may be a word, character, or special symbols.

At step 302, the system 100 may process the document 300 to group text into multiple logical text blocks 304a-304i, wherein one logical block may be separated from the other by whitespace. Each of the logical text blocks 304a-304i may encapsulate a text segment comprising one or more tokens. As an example, the logical text block 304a comprises the tokens “floating”, “amounts” and “:”. As an example, a logical text block, in other words, a text segment, may capture a concept, such as, a topic, paragraph, section, table cells or list.

Techniques of creating such logical text blocks are known. One such technique is taught by Cartic Ramakrishnan et al. in “Layout-aware text extraction from full-text PDF of scientific articles” Source Code Biol. Med., 2012; 7, 7. As an example, the system 100 may create logical text blocks by identifying neighbouring tokens. Referring to FIG. 3A, the system 100 may encapsulate a token “floating” by a text block 202a. The text block 202a may be represented with two pairs of coordinates {(x₁, y₁), (x₂, y₂)}, wherein ‘x₁’ and ‘y₁’ may represent the X and Y axis coordinate of the top-left corner, while ‘x₂’ and ‘y₂’ may represent the X and Y axis coordinate of the bottom-right corner of the text block 202a. The system 100 may then identify and select tokens neighboring the block 202a, by searching for tokens in multiple directions, such as rightwards, leftwards, upwards and downwards directions from the text block 202a. Plurality of tokens within a preset threshold distance may be added to the text block 202a to form an updated text block 202b. The processor 402 may continue searching for neighboring tokens within the threshold distance of the updated text block 202b. The process may continue till all the neighboring tokens 202, within the threshold distance, of the updated text block are combined to create a logical text block.

In an embodiment, the threshold distance may be preset by the processor 102. The threshold distance may be different for different directions. As an example, the threshold distance for the tokens disposed in the upward direction may be different compared to the threshold distance for the tokens disposed in the leftward direction.

As a result of the process discussed above, the system 100 may generate multiple logical text blocks 304a-304i using the document 300. At step 204, the system 100 may select a logical text block for generating features, which may then be used for classification. In conventional methods, the text segments may be classified based on the contextual meaning of tokens relative to other tokens within a text segment. On the other hand, the system 100 may classify each of the logical text block 304a-304i by also considering contextual meaning of tokens in the selected logical text block relative to tokens in qualified neighbouring logical text blocks, which has been observed to lead to improved results.

At step 206, the system identifies logical text blocks neighbouring a logical text block, which has been selected for generating features. It may be noted that, the system 100 may carry out the discussed steps for all or at least some of the logical text block 304a-304i of the document 300. As an example, the system 100 may select the logical text block 304d comprising a single token “Period” and identify logical text blocks neighbouring the selected logical text block 304d. The system 100 may identify the neighbouring logical text blocks disposed along multiple directions from the selected logical text block 304d. As an example, the system 100 may identify the neighbouring logical text blocks disposed in any of upwards, downwards, leftwards, rightwards, and diagonal directions from the selected logical text block 304d.

At step 208, the system 100 may qualify one or more neighbouring blocks for generating the features for the tokens in the selected logical text block 304d. For greater certainty, neighbouring text blocks are not limited to a single closes block, and may include multiple neighbouring text blocks in each direction.

In an embodiment, the system 100 may qualify the neighbouring logical text blocks that may be disposed within a threshold distance from the selected logical text block 304d. The threshold distance for at least one direction may be different from the threshold distance for at least one of the remaining directions. Further, the threshold distance may be a function of the size of the selected logical text block 304d.

In another embodiment, the system 100 may qualify the neighbouring logical text blocks, depending on the size of each of the neighbouring logical text blocks. Further, the size may be a function of the size of the selected logical text block 304d.

In another embodiment, the system 100 may qualify the neighbouring logical text blocks, depending on the number of tokens within the neighbouring logical text blocks. Further, the number of tokens may be a function of the number of tokens of the selected logical text block 304d.

In yet another embodiment, one or more of the criteria discussed above may be applied to qualify the neighbouring logical text blocks.

At step 210, the system 100 may generate features for one or more of the tokens in the selected logical block 304d using one or more of the one or more qualified logical text blocks 204. The system 100 may generate features for tokens in the selected logical block 304d using the tokens in the qualified neighbouring text block, such as qualified logical text block 304h.

In an embodiment, the system 100 may include in the feature the direction in which the qualified logical text block is disposed relative to the selected logical text block. As a generalized example, if “T” is a token in the selected logical text block, “J” is a token in the qualified neighbouring logical text block, and “D” is the direction in which the qualified neighbouring logical text block is disposed relative to the selected logical text block, the feature for the token ‘T’ may be represented as:

Feature=“D|T|J”

The features may be generated by “n”-gram, wherein “n” is at least equal to 1.

As an example, consider the token “period” in the selected logical text block 304d and the qualified neighbouring logical text block 304h. The system may generate features “right|period|end”, “right|period|dates”, “right|period|:” and so on.

In an embodiment, in addition to the direction, the distance may also be included.

In an embodiment, a preconfigured number of tokens may be used in the qualified logical text block for generating the features. Further, some of the tokens in the qualified logical text block may be ignored for the purposes of generating the features.

In an embodiment, the number of tokens used in the qualified logical text block for generating the features may be a function of the number of tokens in the selected logical text block.

The system 100 may provide the features to a classifier for classification. In an embodiment, the text segments in each of the logical text blocks 304 may be classified using one the classifiers provided below.

a. Termination Date-Confirmations.

b. Fixed Rate Day Count Fraction

c. Floating Rate Day Count Fraction

d. Description of Premises:

e. Address of Premises

f. Square Footage of Premises

g. Guarantor

Table. 1 provided below illustrates the experimental results (average lifetime F₁, Recall and precision) when the features generated, as discussed above are fed to the classifiers as compared to conventional feature generation. From the table, Table 1, it can be observed that, all the seven classifiers improve with the inclusion of the neighbouring logical blocks. Recall and F1 improve in all cases, though Precision suffered substantially for classifier (b). This is likely due to Fixed Rates being rarer in the training documents, only appearing in 47 of the 70 documents. Precision only improved by 0.02 on average, while Recall improved by 0.09 on average, indicating that inclusion of the neighbouring logical blocks may help the classifiers distinguish between true positives and false positives, likely due to the false text sequences being very similar to the true sequences, and only being distinguishable by their larger surrounding context. Overall, the F₁ scores of the seven classifiers increases by 0.06 on average.

TABLE 1

| | Without neighbouring | | | Including neighbouring | | |
|---|---|---|---|---|---|---|
| | logical blocks | | | logical blocks | | |
| Classifier | Recall | Precision | F₁ | Recall | Precision | F₁ |
| a | 0.64 | 0.70 | 0.67 | 0.80 | 0.80 | 0.76 |
| b | 0.71 | 0.87 | 0.78 | 0.89 | 0.74 | 0.81 |
| c | 0.89 | 0.69 | 0.78 | 0.92 | 0.92 | 0.92 |
| d | 0.77 | 0.77 | 0.77 | 0.80 | 0.76 | 0.78 |
| e | 0.76 | 0.68 | 0.72 | 0.82 | 0.70 | 0.76 |
| f | 0.79 | 0.76 | 0.77 | 0.82 | 0.76 | 0.79 |
| g | 0.71 | 0.47 | 0.57 | 0.80 | 0.52 | 0.63 |
| Average | 0.75 | 0.71 | 0.72 | 0.84 | 0.73 | 0.78 |

The processes described above is described as a sequence of steps, this was done solely for the sake of illustration. Accordingly, it is contemplated that some steps may be added, some steps may be omitted, the order of the steps may be re-arranged, or some steps may be performed simultaneously.

Referring to FIG. 1, the processor 102 may be implemented as appropriate in hardware, computer-executable instructions, firmware, or combinations thereof. Computer-executable instruction or firmware implementations of the processor 102 may include computer-executable or machine-executable instructions written in any suitable programming language to perform the various functions described. Further, the processor 102 may execute instructions, provided by the various modules of the system 100.

The memory module 104 may store additional data and program instructions that are loadable and executable on the processor 102, as well as data generated during the execution of these programs. Further, the memory module 104 may be volatile memory, such as random-access memory and/or a disk drive, or non-volatile memory. The memory module 104 may be removable memory such as a Compact Flash card, Memory Stick, Smart Media, Multimedia Card, Secure Digital memory, or any other memory storage that exists currently or will exist in the future.

The input/output module 106 may provide an interface for inputting devices such as keypad, touch screen, mouse, and stylus among other input devices, and output devices such as speakers, printer, and additional displays among other.

The display module 110 may be configured to display content. The display module 110 may also be used to receive an input from a user. The display module 110 may be of any display type known in the art, for example, Liquid Crystal Displays (LCD), Light emitting diode displays (LED), Orthogonal Liquid Crystal Displays (OLCD) or any other type of display currently existing or may exist in the future.

The communication interface 112 may provide an interface between the system 100 and external networks. The communication interface 112 may include a modem, a network interface card (such as Ethernet card), a communication port, or a Personal Computer Memory Card International Association (PCMCIA) slot, among others. The communication interface 112 may include devices supporting both wired and wireless protocols.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

1. A method of generating text features from a document, the method carried out by one or more processors, the method comprising the steps of:
a) grouping text comprised in the document into multiple logical text blocks, wherein each of the logical text blocks comprises one or more tokens;
b) selecting one of the logical text blocks for generating features;
c) identifying the logical text blocks neighbouring the selected logical block disposed along multiple directions using associated visual layout information of the text blocks to determine directionality;
d) qualifying one or more of the neighbouring logical text blocks for generating features; and
e) generating features for one or more of the tokens in the selected logical block using one or more of the one or more qualified logical text blocks.

2. The method of claim 1, further comprising, the one or more processors selecting each of the logical text blocks for generating features and carrying out the steps “c” to “f” for each of the selected logical text blocks.

3. (canceled)

4. The method of claim 1, wherein the multiple directions comprise upward, downward, rightward, leftward and diagonal directions from the selected logical text block.

5. The method of claim 1, wherein qualifying the one or more of the neighbouring logical text blocks for generating features comprises the one or more processors qualifying those neighbouring logical text blocks that are within one or more threshold distances from the selected logical text block.

6. The method of claim 5, wherein the threshold distance for at least one direction is different from the threshold distance for at least one of the remaining directions.

7. The method of claim 1, wherein qualifying the one or more of the neighbouring logical text blocks for generating features comprises the one or more processors qualifying the neighbouring logical text blocks based on the size of the neighbouring logical text blocks.

8. The method of claim 1, wherein qualifying the one or more of the neighbouring logical text blocks for generating features comprises the one or more processors qualifying the neighbouring logical text blocks based on the number of words in the neighbouring logical text blocks.

9. The method of claim 1, wherein qualifying the one or more of the neighbouring logical text blocks for generating features comprises the one or more processors qualifying the neighbouring logical text blocks based on combination of distances of the neighbouring logical text blocks from the selected logical text block, the size of the neighbouring logical text blocks and the number of words in the neighbouring logical text blocks.

10. The method of claim 3, wherein generating the features using the qualified logical text block comprises the one or more processors including, in the feature, the direction in which the qualified logical text block is disposed relative to the selected logical text block.

11. The method of claim 10, wherein “n”-gram is used for generating the features, wherein “n” is at least equal to 1.

12. The method of claim 11, wherein a preconfigured number of tokens are used in the qualified logical text block for generating the features.

13. The method of claim 11, wherein one or more tokens in the qualified logical text block are ignored for the purposes of generating the features.

14. The method of claim 10, wherein each of the logical text blocks comprises of the tokens that form logical structure of text, wherein one logical block is separated from the other by whitespace.

15. The method of claim 14, wherein each of the logical text blocks captures concept comprising one of paragraph, section, table cells or list.

16. The method of claim 1, further comprising, prior to the qualifying step, classifying the directionality of each of the logical text blocks by considering contextual meaning of the tokens in the selected logical text block relative to tokens in qualified neighboring logical text blocks.
